(19) United States
(12) Patent Application Publication
(10) Pub. No.: US 2006/0096470 A1
(43) Pub. Date: May 11, 2006

(54) Apparatus for peeling outer skins of garlic using wet process

(76) Inventor: Sung Gi Baek, Daegu-city (KR)

Correspondence Address: NATH & ASSOCIATES, 112 South West Street, Alexandria, VA, 22314, US

(21) Appl. No.: 10/532,762

(22) PCT Filed: Nov. 5, 2003
(86) PCT No.: PCT/KR03/02353

§ 371 Date: Apr. 27, 2005

(30) Foreign Application Priority Data
Nov. 12, 2002 (KR) 10-2002-0070159
Apr. 4, 2003 (KR) 20-2003-0010301
Jun. 2, 2003 (KR) 20-2003-0017182

(51) Int. Cl. A47J 17/00

(52) U.S. Cl. 99/584

(57) ABSTRACT

Disclosed is an apparatus for peeling the outer skins of garlic using a wet process that is provided with a garlic bulb splitting part (100) and a garlic clove peeling part (200) that have different structures from each other, to thereby improve the capabilities both in the separation of the garlic bulbs and the peeling of the outer skins of the garlic cloves and to thereby improve the separation of the garlic meats from the outer skins in the steps where the garlic cloves are put into each garlic clove peeling part (200), and with a separate water discharging tank (700) for purifying the water used for the peeling of the garlic before discharging to thereby prevent environmental contamination.

### TECHNICAL FIELD

The present invention relates to an apparatus for peeling the outer skins of garlic using a wet process, and more particularly, to an apparatus for peeling the outer skins of garlic using a wet process that is provided with a garlic bulb splitting part and a garlic clove peeling part that have different structures from each other, to thereby improve the capabilities both in the separation of the garlic cloves and the peeling of the outer skins of the garlic, with a plurality of garlic clove peelers that are employed to remove the outer skins from the garlic cloves, to thereby improve the peeling efficiency of the outer skins, and with activated charcoal that is adapted to purify the water used in a wet process for peeling the outer skins before discharging, to prevent environmental contamination.

### BACKGROUND ART

As well known, garlic has been used as one of spices in, cooking almost all kinds of food. Recently, as it has been proved that garlic actually has the various medicinal advantages, a number of countries such as Japan, U.S.A., and so on have tried to develop the food containing garlic.

Generally, garlic cloves have outer skins for protecting the body of each clove, but before it is put as food, the outer skins must be removed.

When the garlic is peeled off, it should be careful that the surface layer of the meat of the garlic is not damaged. If the surface layer is damaged to cut the interior of the meat, sticky liquid flows from the meat of the garlic, which causes some disadvantages that the garlic working efficiency becomes low, the hands peeling garlic become hurt because of the garlic constituents, and the part around the cut meat gets dirty to get harmful bacteria so that it may be easily rotten.

When the garlic is peeled off, by the way, it is peeled by using a knife, which of course makes the surface layer of the meat of garlic much damaged, needs a large quantity of time consumption, and has got a problem that a user might cut his or her fingers. So lots of homes or stores tend to purchase the garlic from which the outer skins have been removed. To satisfy the desires for the garlic that have been peeled off, large factories are recently built to supply a large amount of garlic to stores or marts. Some of them have used their own machines that they developed, and some have lent a desired machine with the payment of royalties.

Generally, a garlic peeler is divided into two types: The first type is one using a wet process and the second type is one using a dried process. The garlic peeler using the dried process removes the outer skin of the garlic by use of a pair of rubber rollers, which has some defects that a restriction in peeling a number of garlic is accompanied, it gives damages to the meats of the garlic, and the outer skins removed from the garlic are blown in every direction. To remove these problems, the garlic peelers using the wet process are widely used. In the known technologies, however, the conventional garlic peeler just removes the outer skins from the garlic soaked in water through the rubber rollers. In these steps, the peculiar flavors the garlic has get decreased such that its value as a product must be diminished. And, the step of keeping the garlic soaked in water is additionally carried out, which of course causes the work efficiency to be low. In addition, the peeling is not completely done such that it should be done again at a subsequent step, and the garlic having different sizes gets damaged while passing between the rollers having no tension. Also, the garlic that has been peeled off remains with a little moisture such that it may be rotten.

Therefore, there is presented Korean Patent Application No. 2001-44155 disclosing the garlic peeler using the wet process, as filed by the same applicant as this invention. According to the preferred embodiment, the garlic peeler using the wet process includes: a hopper in which garlic cloves are poured; a garlic bulb throwing part being formed of a conveyor on the lower portion of the hopper, for providing garlic bulbs by small quantities by the control of the moving speed of the conveyor; three garlic peeling parts for injecting high-pressure water from the lower portion thereof to the garlic cloves or the garlic bulbs, making the garlic cloves or the garlic bulbs contact with the streamlined side on the internal back thereof and rotated therein, such that the garlic bulbs become individual garlic cloves and the garlic cloves remove their outer skins; two outer skin and garlic meat separating parts for conveying the clove or bulb skins and the garlic meats extracted from the three garlic peeling parts through an adhering meshes conveyor and for separating the garlic meats and the outer skins by the control of the installation angle of the adhering meshes conveyor; a dry part for blowing an air to the garlic meats such that the garlic meats are completely dried, while conveying the garlic meats on a conveyor; a garlic meat discharging part for discharging the dried garlic meats by means of a conveyor; two outer skin discharging parts for sweeping the outer skins with a brush conveyor with a result that the outer skins are automatically discharged; a water circulating part for keeping water circulated to the three garlic peeling parts and the two outer skin and garlic meat separating parts; and a conveyor part for conveying the garlic to each corresponding step. With the aforementioned garlic peeler, the garlic bulbs can be processed without a separate step of soaking them in water such that each of the garlic bulbs is split into its component cloves and removes the outer skin from each clove by means of the plurality of garlic peeling parts. This enables the garlic after the processing to keep its peculiar flavors. Also, the garlic meats and the outer skins are separated by means of the two outer skin and garlic meat separating parts, which enables the garlic bulbs or the garlic cloves to be split and peeled off in an efficient, fast manner.

In spite of such the advantages, however, the aforementioned prior art has some disadvantages that the three garlic peeling parts have the same structure as one another, such that when the garlic bulbs are split to the component cloves, they are too small in volume to be split to the cloves and when the garlic cloves are peeled off, they are passed at a substantially fast speed such that they are not peeled completely. During these steps, the outer skins that have been already removed from the garlic are continuously moved to next steps, with a consequence that the garlic is not completely peeled off because of the obstacle of the outer skins that have been already removed from the garlic. Furthermore, the garlic meats and the outer skins are mixed to each other, such that they are difficult to be separated.

On the other hand, the water after the use of the peeling is directly discharged, without having any purifying process through separate purifying equipment. This of course causes the surrounding environment and water quality to be badly contaminated.

### DISCLOSURE OF INVENTION

Accordingly, the present invention has been made to solve the above-described problems, and it is an object of the present invention to provide an apparatus for peeling the outer skins of garlic using a wet process that is provided with a garlic bulb splitting part and a garlic clove peeling part that have different structures from each other, to thereby improve the capabilities both in the separation of the garlic bulbs and the peeling of the outer skins of the garlic cloves and to thereby improve the separation of the garlic meats from the outer skins in the steps where the garlic cloves are thrown into each garlic clove peeler, and with a separate purifying system for purifying the water used for the peeling of the garlic before discharging to thereby prevent environmental contamination.

To accomplish the above object, according to the present invention, there is provided an apparatus for peeling the outer skins of garlic using a wet process, the apparatus including: a garlic bulb splitting part for injecting high-pressure water to garlic bulbs to split the garlic bulbs into individual garlic cloves;

a garlic clove peeling part having at least three garlic clove peelers arranged one after another and a conveyor provided between adjacent garlic clove peelers for separating and conveying the outer skins and the garlic meats containing water therein discharged from each garlic clove peeler, the garlic clove peeling part adapted to inject high-pressure water to the split garlic cloves when the split garlic cloves are provided from the garlic bulb splitting part to thereby peel the outer skins of the garlic cloves;

a dry part for blowing air to the garlic meats by means of an air blower such that the garlic meats are fully dried, while conveying the garlic meats from the garlic clove peeling part through a conveyor; an outer skin separating parts provided between the garlic bulb splitting part and a first garlic clove peeler and between a final garlic clove peeler and the dry part, respectively, for conveying the garlic cloves or the garlic meats from the garlic bulb splitting part or the garlic clove peeling part such that the garlic meats are dropped to first and second water paths by the control of an installation angle thereof and the outer skins are caught by first and second meshes conveyors; an outer skin discharging part provided with a discharging chamber having a gutter communicating with the lower portions of the first and second meshes conveyors and with the lower portion of each conveyor of the garlic clove peeling part, a perforated plate communicating with the gutter, and a brush conveyor for sweeping and discharging the water and outer skins dropped through the gutter flowing into the discharging chamber; a water circulating part having a first settling tank for pumping water to each garlic clove peeler, a second settling tank placed to gather water filtered through the perforated plate at the lower portion of the discharging chamber, pumping the water to the first water path of the first meshes conveyor and the first settling tank, and a third settling tank placed at the lower portion of the dry part, for supplying water to the second water path of the second meshes conveyor and for circulating the water gathering again through the dry part; and a water discharging tank having a fourth settling tank and a filtering tank, the filtering tank having activated charcoal filled therein and filtering meshes provided at the upper portion thereof, for purifying the water flowing from the fourth settling tank by the use of the activated charcoal when the water is pumped from the first settling tank to discharge the purified water.

### BRIEF DESCRIPTION OF THE DRAWINGS

Further objects and advantages of the invention can be more fully understood from the following detailed description taken in conjunction with the accompanying drawings, in which:

FIG. 1 is a schematic view showing a configuration of an apparatus for peeling the outer skins of garlic according to the present invention;

FIG. 2a is a schematic view of the garlic bulb splitting part of the apparatus of this invention;

FIG. 2b is a perspective view of FIG. 2a;

FIG. 2c is a sectional view of FIG. 2a;

FIG. 2d is a detailed sectional view of a nozzle part;

FIG. 2e is a sectional view taken along the line A-A′ of FIG. 2d;

FIG. 2f is a sectional view taken along the line B-B′ of FIG. 2d;

FIG. 3a is a schematic view of an outer skin separating part of the apparatus of this invention;

FIG. 3b is a view of a first meshes conveyor;

FIG. 3c is a view of a second meshes conveyor;

FIG. 4a is a schematic view of the garlic clove peeling part of the apparatus of this invention;

FIG. 4b is a perspective view of FIG. 4a;

FIG. 4c is a sectional view of FIG. 4a;

FIG. 4d is a detailed sectional view of a nozzle part;

FIG. 4e is a sectional view taken along the line C-C′ of FIG. 4d;

FIG. 4f is a sectional view taken along the line D-D′ of FIG. 4d;

FIG. 5 is a view of a dry part of the apparatus of this invention;

FIG. 6 is a view of a garlic meat discharging part of the apparatus of this invention;

FIG. 7 is a view of an outer skin discharging part of the apparatus of this invention;

FIG. 8 is a view of a water circulating part and a water discharging tank of the apparatus of this invention;

FIG. 9 is an exploded perspective view of another example of the garlic bulb splitting part or the garlic clove peeler;

FIG. 10 is a sectional view of FIG. 9;

FIG. 11a is a view of a group of nozzles of FIG. 9;

FIG. 11b is a front sectional view of the group of nozzles;

FIG. 11c is a sectional view taken along the line A-A′ of FIG. 11b;

FIG. 11d is a sectional view taken along the line B-B′ of FIG. 11b;

FIG. 12 is an exploded perspective view of yet another example of the garlic bulb splitting part or the garlic clove peeler; and

FIG. 13 is a sectional view of FIG. 12.

### BEST MODE FOR CARRYING OUT THE INVENTION

Now, an explanation of the preferred embodiment of the present invention will be given.

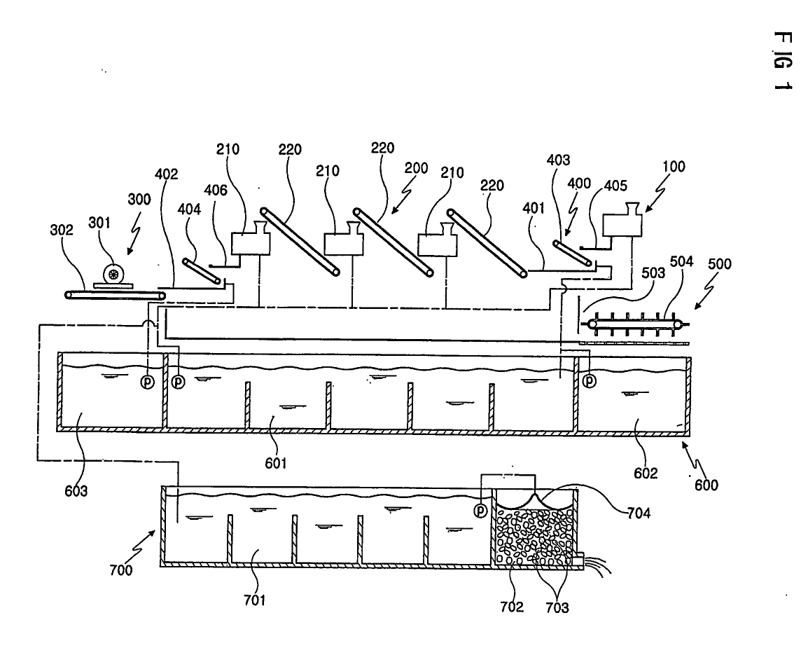

As shown in FIG. 1 an apparatus for peeling the outer skins of garlic using a wet process according to the present invention includes: a garlic bulb splitting part 100 for injecting high-pressure water to garlic bulbs to split the garlic bulbs into individual garlic cloves; a garlic clove peeling part 200 having at least three garlic clove peelers 210 arranged one after another and a conveyor 220 provided between adjacent garlic clove peelers 210 for separating and conveying the outer skins and the garlic meats containing water therein discharged from each garlic clove peeler 210, the garlic clove peeling part 200 adapted to inject high-pressure water to the split garlic cloves to peel the outer skins of the garlic cloves when the split garlic cloves are provided from the garlic bulb splitting part 100; a dry part 300 for blowing air to the garlic meats by means of an air blower 301 such that the garlic meats are fully dried, conveying the garlic meats from the garlic clove peeling part 200 through a conveyor 302; an outer skin separating part 400 provided between the garlic bulb splitting part 100 and a first garlic clove peeler 210 and between the final garlic clove peeler 210 and the dry part 300, respectively, for conveying the garlic cloves or the garlic meats from the garlic bulb splitting part 100 or the garlic clove peeling part 200 such that the garlic meats are dropped to first and second water paths 401 and 402 by the control of an installation angle thereof and the outer skins are caught by first and second meshes conveyors 403 and 404; an outer skin discharging part 500 provided with a discharging chamber 503 having a gutter 501 communicating with the lower portions of the first and second meshes conveyors 403 and 404 and with the lower portion of each conveyor 220 of the garlic clove peeling part 200, a perforated plate 502 communicating with the gutter 501, and a brush conveyor 504 for sweeping and discharging the water and outer skins dropped through the gutter 501 flowing into the discharging chamber 503; a water circulating part 600 having a first settling tank 601 for pumping water to each garlic clove peeler 210, a second settling tank 602 placed to gather water filtered through the perforated plate 502 at the lower portion of the discharging chamber 503, pumping the water to the first water path 401 of the first meshes conveyor 403 and the first settling tank 601, and a third settling tank 603 placed at the lower portion of the dry part 300, for supplying water to the second water path 402 of the second meshes conveyor 404 and for circulating the water gathering again through the dry part 300; and a water discharging tank 700 having a fourth settling tank 701 and a filtering tank 702, the filtering tank 702 having activated charcoal 703 filled therein and filtering meshes 704 provided at the upper portion thereof, for purifying the water flowing from the fourth settling tank 701 by the use of the activated charcoal 704 when the water is pumped from the first settling tank 601 to discharge the purified water.

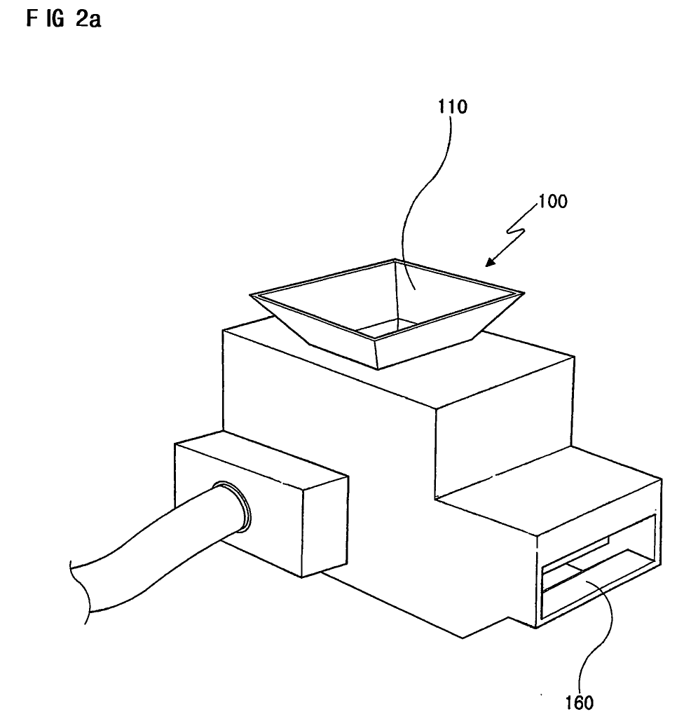

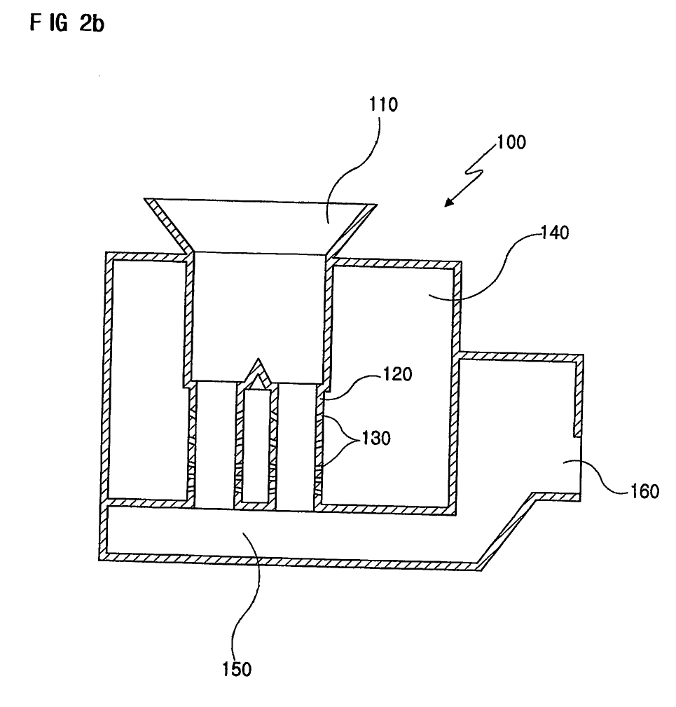

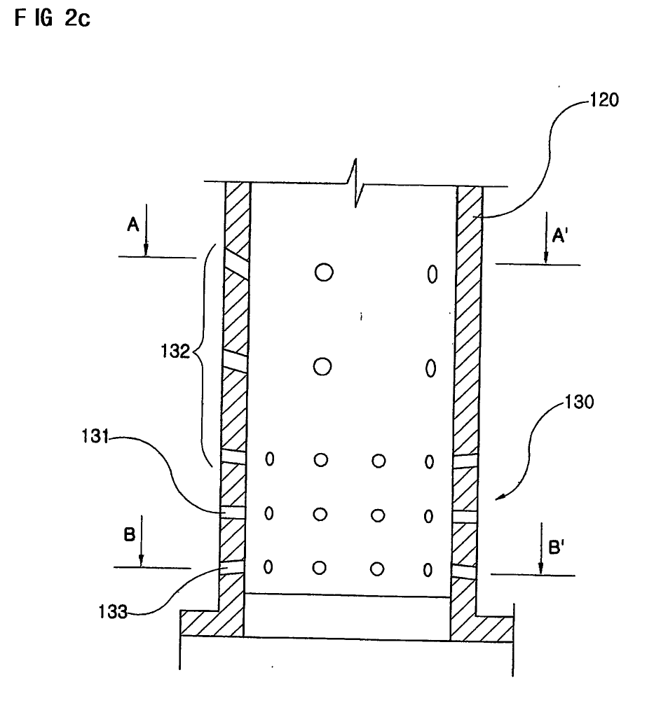

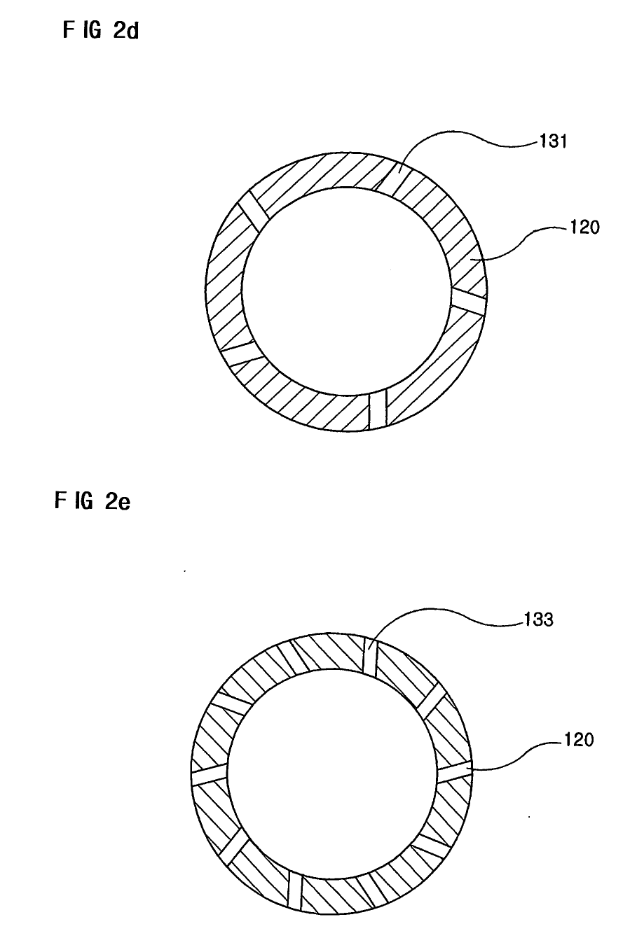

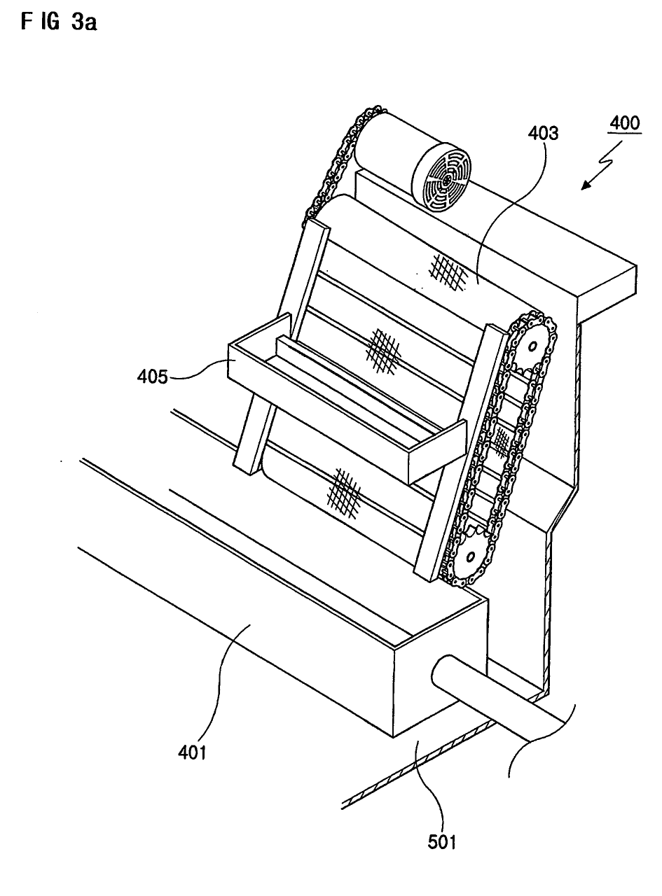

As shown in FIGS. 2a to 2e, the garlic bulb splitting part 100 includes: a garlic bulb putting hopper 110 into which garlic bulbs are thrown; a cylindrical garlic bulb putting tube 120 into which the garlic bulbs are put, extended downwardly from the garlic bulb putting hopper 110; a group of multistage nozzles 130 spaced equally along a circumferential direction from the middle portion to the lower portion of the garlic bulb putting tube 120; a water storing tank 140 placed near the garlic bulb putting tube 120 for supplying water to the group of multistage nozzles 130; a conveying passage 150 communicating in a horizontal direction with the lower end of the garlic bulb putting tube 120; and a discharging outlet 160 communicating slantly in an upward direction with the conveying passage 150. In this case, the group of multistage nozzles 130 include reference nozzles 131 that are positioned in a vertical direction to the garlic bulb putting tube 120 at the lower portion of the garlic bulb putting tube 120, upper nozzles 132 that are positioned at the upper portion with respect to the reference nozzles 131, spaced at intervals that become large by stages and slanted at angles that become large by stages toward the lower portion as they reach the upper portion, and lower nozzles 133 that are positioned at the lower portion with respect to the reference nozzles 131, spaced at intervals that become large by stages and slanted at angles that become large by stages toward the upper portion as they reach the lower portion. The reference nozzles 131 are formed in such a manner that the unit nozzles aligned along the circumferential direction are directed to the middle portion of the garlic bulb putting tube 120, and the unit nozzles of the upper and lower nozzles 132 and 133 are formed in turn in such a manner as to be directed to the left or right with respect to the middle portion of the garlic bulb putting tube 120.

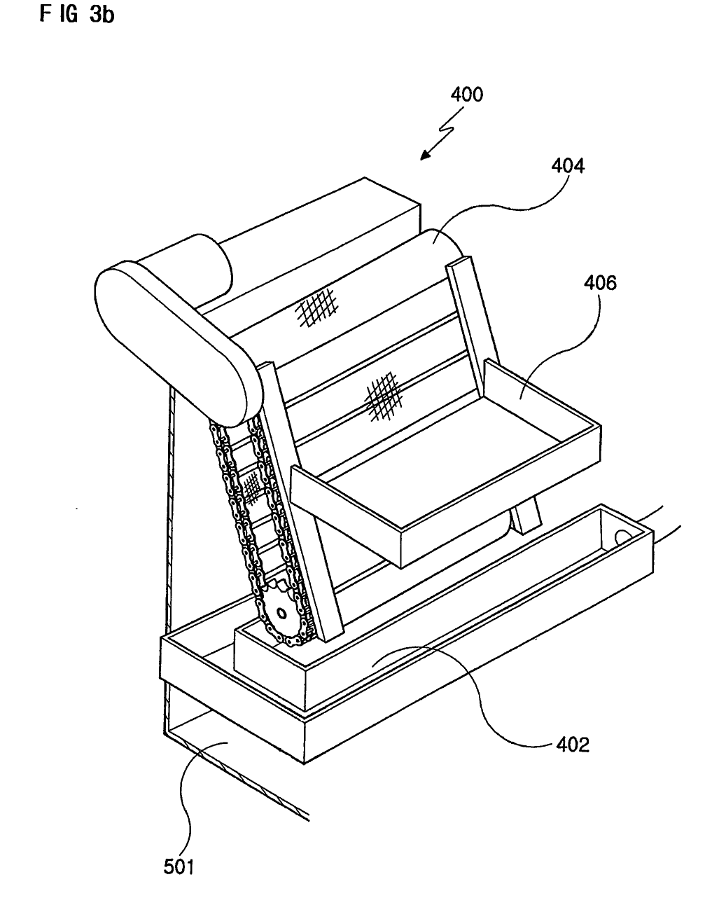

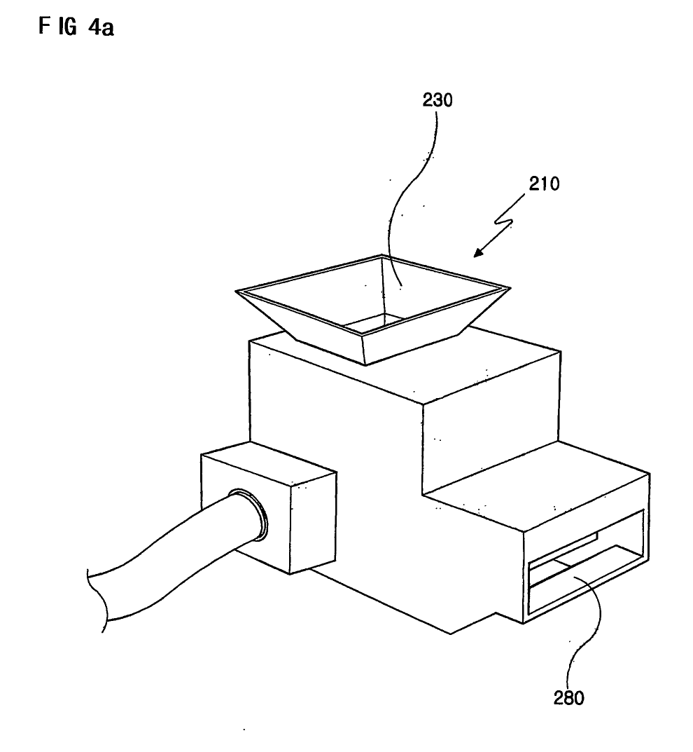

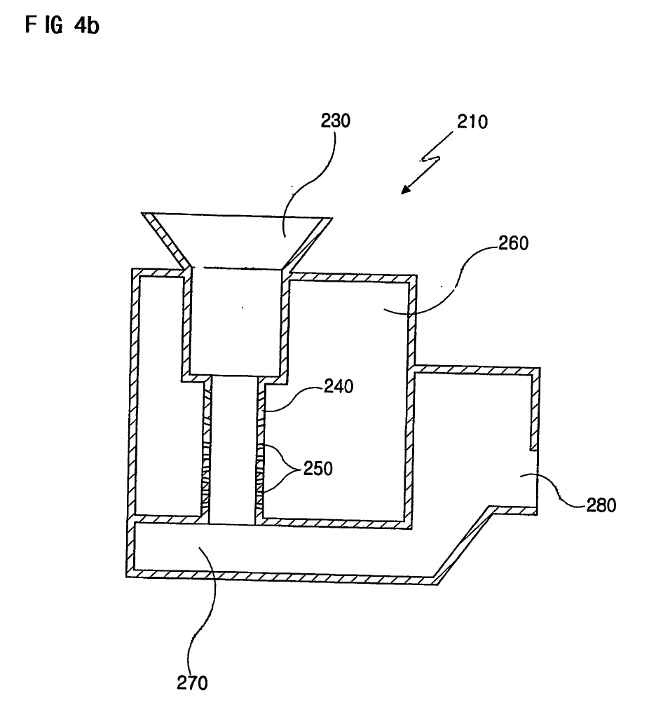

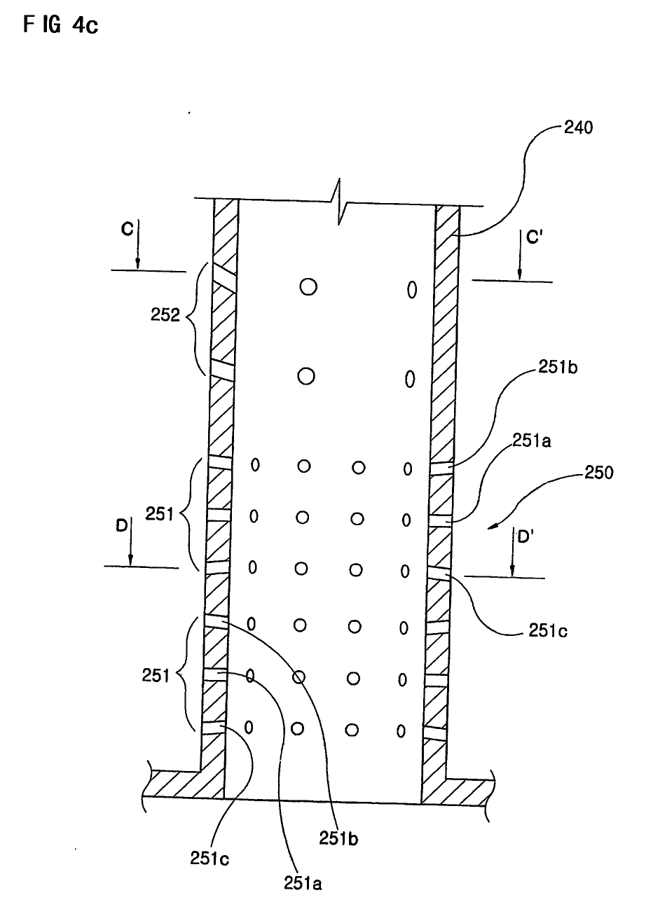

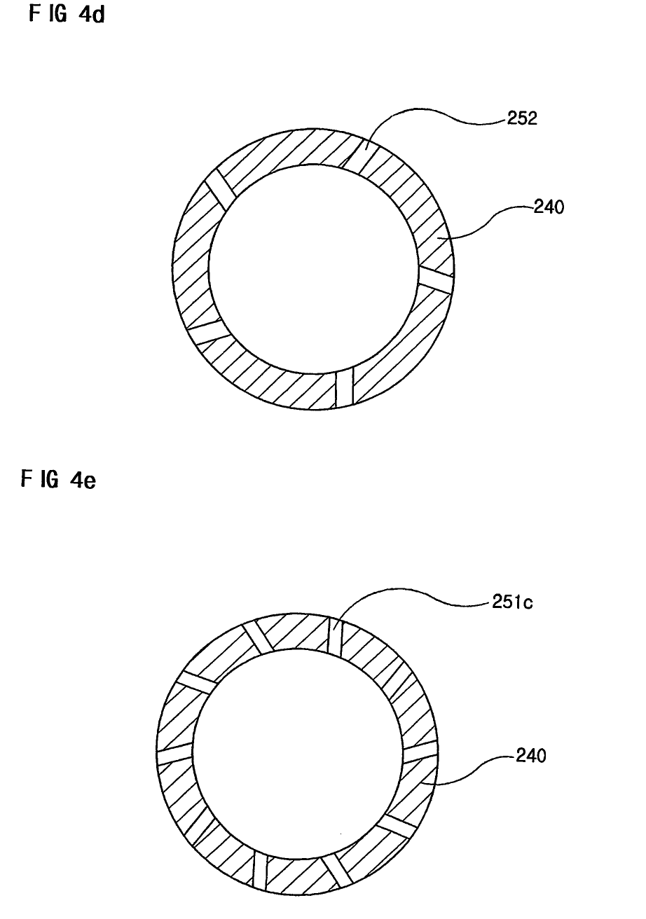

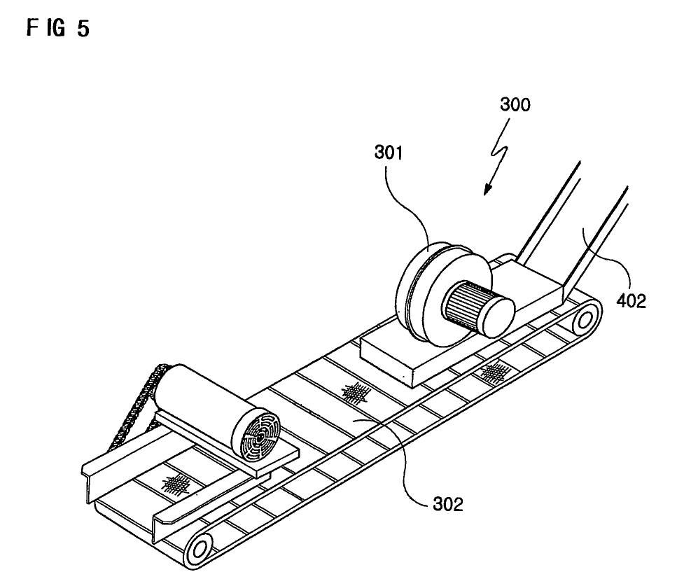

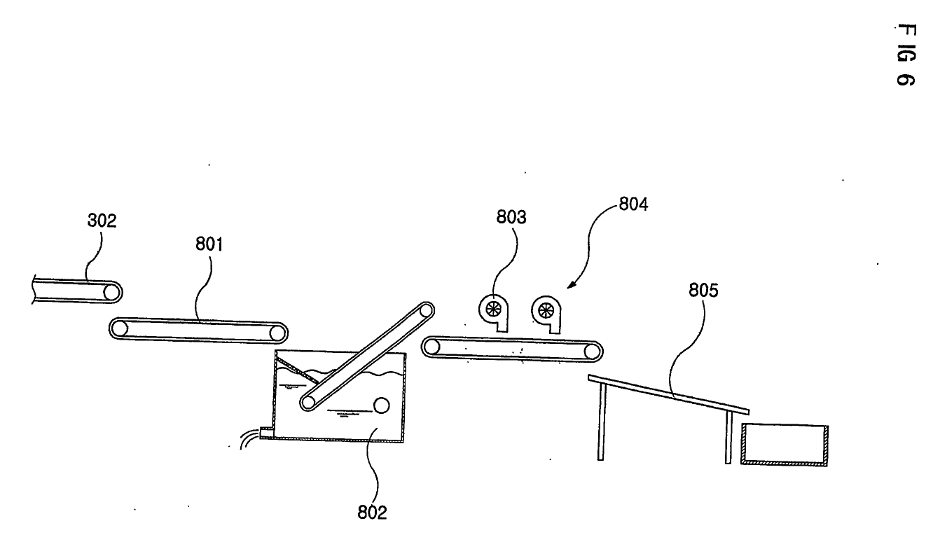

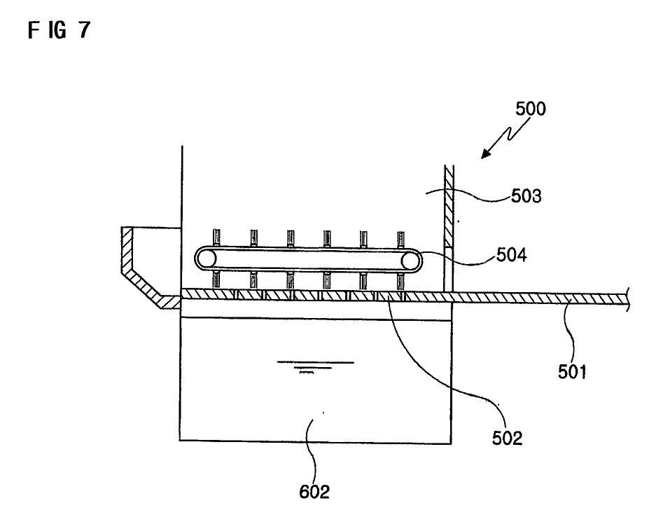

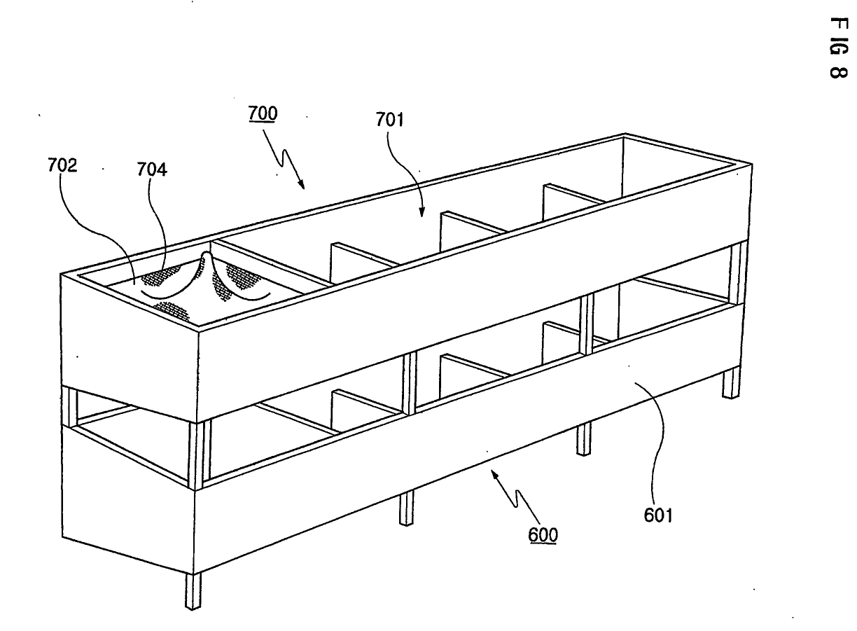

As shown in FIGS. 3a to 3c, each of the garlic clove peelers 210 in the garlic clove peeling part 200 includes: a garlic clove putting hopper 230 into which garlic cloves are thrown; a cylindrical garlic clove putting tube 240 into which the garlic cloves are put, extended downwardly from the garlic clove putting hopper 230; a group of multistage nozzles 250 spaced equally along a circumferential direction from the middle portion to the lower portion of the garlic clove putting tube 240; a water storing tank 260 placed near the garlic clove putting tube 240 for supplying water to the group of multistage nozzles 250; a conveying passage 270 communicating in a horizontal direction with the lower end of the garlic clove putting tube 240; and a discharging outlet 280 communicating slantly in an upward direction with the conveying passage 270. In this case, the group of multistage nozzles 250 are provided with at least two sets of peeling nozzles 251 each having the three-stage nozzles starting at the lower portion thereof, each set of peeling nozzles 251 having intermediate nozzles 251a positioned in a vertical direction to the garlic clove putting tube 240, upper nozzles 251b positioned slantly in a downward direction, and lower nozzles 251c positioned slantly in an upward direction in such a manner as to be symmetrical to the upper nozzles 251b. The upper nozzles 252 that are placed at the upper portion with respect to the sets of peeling nozzles 251 are positioned slantly downwardly at a larger angle than the slanted angle of the upper or lower nozzles 251b or 251c of the sets of peeling nozzles 251. The intermediate nozzles 251a of each of the two sets of peeling nozzles are formed in such a manner that the unit nozzles aligned along the circumferential direction are directed to the middle portion of the garlic clove putting tube 240, and the unit nozzles of the upper and lower nozzles 251b, 251c and 252 are formed in turn in such a manner as to be directed to the left or right with respect to the middle portion of the garlic clove putting tube 240.

At the rear of the dry part 300, there is provided a garlic meat discharging part 800 including a post-processing conveyor 801 where the garlic cloves that have not been peeled off, the outer skins, and the garlic stalks are separated manually, a washing tank 802, a dewatering conveyor 804 for removing the water remaining on the garlic meats by use of air blowers 803, and a size sorter 805 on which the garlic meats are sorted by sizes as it is vibrated. And, the filtering meshes 704 of the water discharging tank 700 have a W-shaped section portion, such that water flows to the central portion thereof.

The dry part 300 and the one side of the discharging chamber 503 are connected via a pipe which is not shown in the drawing, such that the outer skins blowing while dried in the dry part 300 are sent to the discharging chamber 503. It is also obvious to those skilled in the art that an additional garlic bulb putting device is provided to the garlic bulb splitting part 100. Each conveyor has a motor and a chain for driving itself, and also, there is provided a control box for controlling each motor, pump and air blower.

Reference numerals 405 and 406 indicate distributing plates for evenly spreading the garlic meats and the outer skins to move them to the meshes conveyors 403 and 404.

Now, an explanation of the apparatus for peeling the outer skins of the garlic according to the present invention will be given.

First of all, if the garlic bulbs are thrown into the garlic bulb putting hopper 110 of the garlic bulb splitting part 100, the garlic bulbs are moved to the garlic bulb putting tube 120 and get struck by the pressure of water injected from the group of nozzles 130 arranged from the middle portion to the lower portion of the garlic bulb putting tube 120, with a result that the garlic bulbs are split to the garlic cloves. As noted above, in this case, the group of multistage nozzles 130 have the reference nozzles 131 that are positioned in a vertical direction to the garlic bulb putting tube 120 at the lower portion of the garlic bulb putting tube 120, the upper nozzles 132 that are positioned at the upper portion with respect to the reference nozzles 131, spaced at intervals that become large by stages and slanted at angles that become large by stages toward the lower portion as they reach the upper portion, and the lower nozzles 133 that are positioned at the lower portion with respect to the reference nozzles 131, spaced at intervals that become large by stages and slanted at angles that become large by stages toward the upper portion as they reach the lower portion. As a result, the garlic bulbs can be moved downwardly by the strikes of the water from the upper nozzles 132, without having any additional pushing device, and they stay for a predetermined period of time by means of the less number of upwardly slanted lower nozzles 133 than the upper nozzles 132, not being passed directly at a relatively rapid speed. In this step, the garlic bulbs are further struck by the high pressure of water.

As described above, also, the reference nozzles 131 are formed in such a manner that the unit nozzles aligned along the circumferential direction are directed to the middle portion of the garlic bulb putting tube 120, and the unit nozzles of the upper and lower nozzles 132 and 133 are formed in turn in such a manner as to be directed to the left or right with respect to the middle portion of the garlic bulb putting tube 120. As a result, the water injected from the nozzles 132 and 133 at each stage is in an opposite direction to those at the stages adjacent thereto, such that the water is rotated in opposite directions to one another by stages in the garlic bulb putting tube 120. And, in the steps where the garlic bulbs are passed through the water rotating in the opposite directions to one another by stages, they are struck and evenly collided against one another in the water flowing directions, with a result that they are split into the garlic cloves.

At this time, since the number of upper nozzles 132 slantly downwardly is larger than that of lower nozzles 133 slantly upwardly, the garlic cloves are discharged from the garlic bulb putting tube 120 and moved through the conveying passage 150 to the discharging outlet 160.

The garlic cloves that have been discharged from the garlic bulb splitting part 100 are evenly spread on the distributing plate 405 and move to the first meshes conveyor 403. At this time, the garlic cloves are dropped to the water path 401, and the bulb skins and water are moved to the gutter 501. At next step, they are moved through the water path 401 into which water is supplied from the second settling tank 602 and are then sent to the garlic clove peeling part 200 via the conveyor 220.

As noted above, the garlic clove peeling part 200 is provided with the three garlic clove peelers 210 arranged one after another and the conveyor 220 provided between adjacent garlic clove peelers 210 for separating and conveying the outer skins and the garlic meats containing water therein discharged from each garlic clove peeler 210. Through the steps, the garlic cloves are completely peeled.

That is to say, the garlic clove peeler 210 has the garlic clove putting hopper 230 where the garlic cloves gather together and are moved to the garlic clove putting tube 120, being struck by the pressure of water injected from the group of nozzles 250 arranged from the middle portion to the lower portion of the garlic bulb putting tube 120, with a result that the garlic cloves are peeled off. As noted above, in this case, the group of multistage nozzles 250 are provided with the two sets of peeling nozzles 251 each having the three-stage nozzles starting at the lower portion thereof, each set of peeling nozzles 251 having the intermediate nozzles 251a positioned in a vertical direction to the garlic clove putting tube 240, having the upper nozzles 251b positioned slantly in a downward direction, and having the lower nozzles 251c positioned slantly in an upward direction in such a manner as to be symmetrical to the upper nozzles 251b. The upper nozzles 252 that are placed at the upper portion with respect to the sets of peeling nozzles 251 are positioned slantly downwardly at a larger angle than the slanted angle of the upper or lower nozzles 251b or 251c of the sets of peeling nozzles 251. As a result, the garlic cloves can be smoothly moved downwardly by the strikes of the water from the upper nozzles 252, without having any additional pushing device, and they are passed through the sets of peeling nozzles 251, supported by the pressure of water from the lower nozzles 251c slanted upwardly, such that they stay for a predetermined period of time, not being passed directly at a relatively rapid speed. In this step, the garlic cloves are further struck by the high pressure of water. These steps are repeated at least two times or more, so the garlic cloves are further struck against water and completely peeled.

As noted above, the intermediate nozzles 251a of each of the two sets of peeling nozzles are formed in such a manner that the unit nozzles aligned along the circumferential direction are directed to the middle portion of the garlic clove putting tube 240, and the unit nozzles of the upper and lower nozzles 251b, 251c and 252 are formed in turn in such a manner as to be directed to the left or right with respect to the middle portion of the garlic clove putting tube 240. As a result, the water injected from the nozzles 251b, 251c and 252 at each stage is in an opposite direction to those at the stages adjacent thereto, such that the water is rotated in opposite directions to one another by stages in the garlic clove putting tube 240. And, in the steps where the garlic cloves are passed through the water rotating in the opposite directions to one another by stages, they are struck and evenly collided against one another in the water flowing directions, with a result that they are peeled off, preventing the garlic meats from being broken. At this time, since the number of nozzles 251b and 252 slantly downwardly is larger than that of nozzles 251c slantly upwardly, the garlic cloves that have been peeled are discharged from the garlic clove putting tube 240 and moved through the conveying passage 270 to the discharging outlet 280. The above steps are repeated three times, so the garlic cloves are completely peeled, and in the step of moving to the conveyor 220, the garlic meats are separated from the outer skins, the garlic stalks and the water.

The garlic meats that have been discharged from the final garlic clove peeler 210 are evenly spread on the distributing plate 406 and move to the second meshes conveyor 404 of the outer skin separating part 400. At this time, the garlic meats are dropped to the water path 402, and the outer skins and water are moved to the gutter 501. At next step, they are moved through the water path 402 into which water is supplied from the third settling tank 603 and are then sent to the dry part 300. The garlic meats are moved through the conveyor 302 and dried by activation of the air blowers 301 on the upper portion thereof.

At the rear of the dry part 300, as noted above, there is provided the garlic meat discharging part 800. In the step where the garlic meats that have been passed through the conveyor 302 are moved through the post-processing conveyor 801, the garlic cloves that have not been peeled off, the outer skins, and the garlic stalks are separated manually. At next step, the garlic meats are passed through the washing tank 802, the dewatering conveyor 804 for removing the water remaining on the garlic meats by use of the air blowers 803, and the size sorter 805 on which the garlic meats are sorted by sizes as it is vibrated, such that the garlic meats are washed and dried, without having any foreign materials thereon, and they are automatically sorted for packaging by sizes.

The outer skins, the garlic stalks and water gather all to the gutter 501 communicating with the lower portions of the first and second meshes conveyors 403 and 404 and with each of the conveyors 220 and move to the discharging chamber 503. In this state, the water is filtered through the perforated plate 502 and flows to the second settling tank 602, and the outer skins and the garlic stalks are swept by the brush conveyor 504 and then discharged through the outer skin discharging outlet on the one side thereof. The predetermined tube is connected between the one sides of the dry part 300 and the discharging chamber 503, such that the outer skins blowing during drying are sent to the discharging chamber 503.

On the other hand, the first settling tank 601 into which water is first filled pumps the water and supplies it to the garlic bulb splitting part 100 and each garlic clove peeler 210 of the garlic clove peeling part 200, wherein the water gathers to the gutter 501 and moves to the second settling tank 602 through the discharging chamber 503. By pumping operation of the second settling tank 602, the water is moved again to the first settling tank 601. Therefore, the first settling tank 601 desirably has a plurality of compartments for settling foreign materials therein, and it places the pump at the opposite portion to the water flowing side.

The third settling tank 603 in which new refresh water is filled pumps the water and gathers the water again through the water path 402 and the dry part 300. At this time, the garlic meats are almost washed, but the third settling tank 603 has a perforated plate on the upper portion thereof, such that a small quantity of foreign materials or outer skins that may remain on the garlic meats are completely separated. Preferably, in this case, the perforated plate should be cleaned periodically.

The water used for peeling the garlic for about 12 hours is too dirty to be further used, so that it should be purified for recycling or discharging. In this embodiment of the present invention, the apparatus of this invention further includes the water discharging tank 700 having the settling tank 701 and the filtering tank 702. Thus, a pipe with a pump therein is disposed between the first settling tank 601 of the water circulating part 600 and the water discharging tank 702, for pumping the water after use for about 12 hours, and another pipe with a pump therein is disposed between the settling tank 701 and the filtering tank 702 of the water discharging tank 702, for pumping the water from the settling tank 701 to the filtering tank 702. In this case, the filtering tank 702 contains the activated charcoal 703 having an excellent adhering capability, such that in the step where the water is passed through the filtering tank 702, the foreign materials adhere to the activated charcoal 703. Thus, the water is purified and recycled for peeling the garlic or discharged to the outside.

At this time, the filtering meshes 704 at the top portion of the filtering tank 702 have a W-shaped section portion, such that the water flowing from the settling tank 701 flows to the central portion of the filtering meshes 704. Thus, the large particles of foreign materials that have not been filtered through the filtering meshes 704 gather to the edge portions thereof, such that the slanted portions are kept cleanly. Therefore, the filtering meshes 704 cannot be blocked due to the foreign materials, and the foreign materials gathering on the filtering meshes 704 are removed periodically.

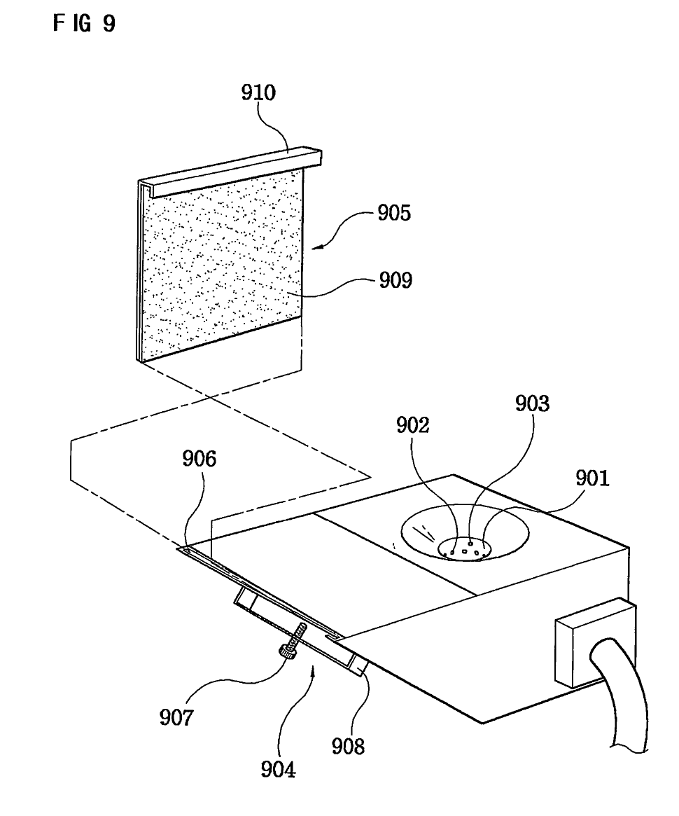

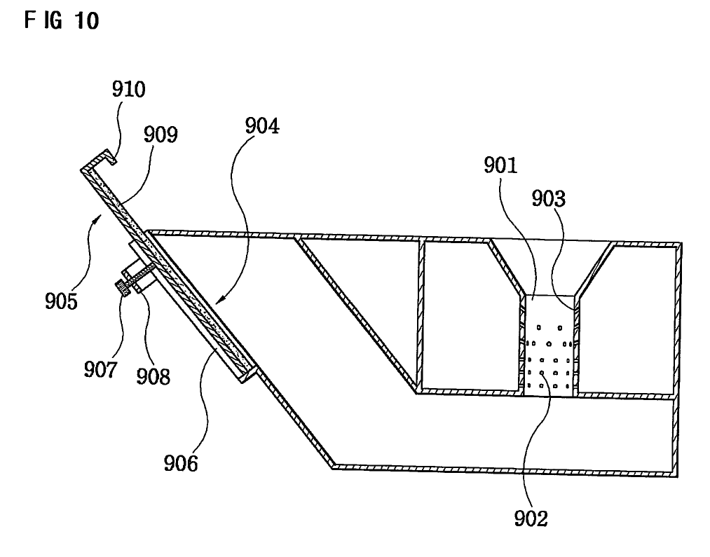

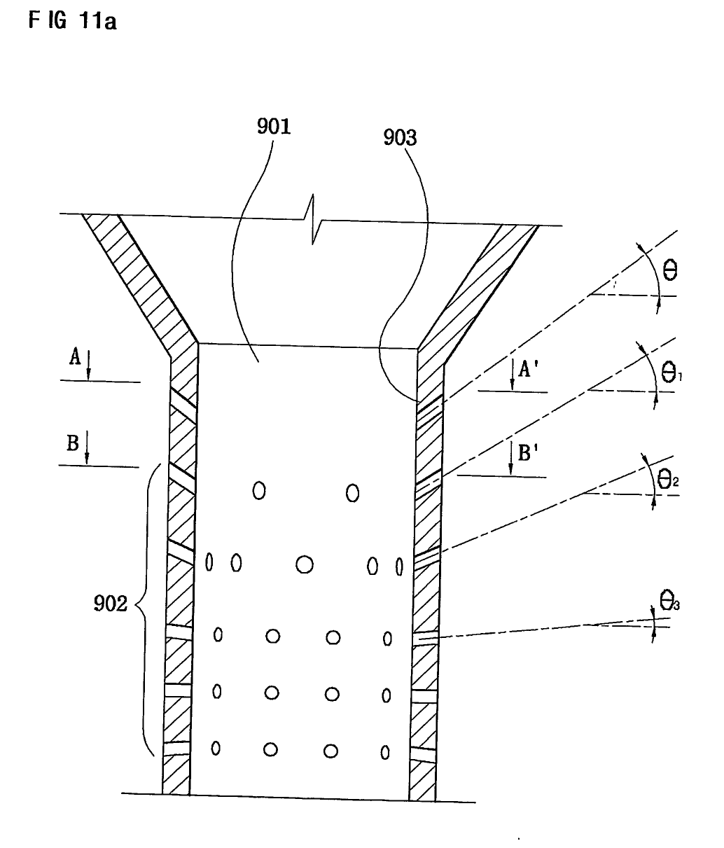

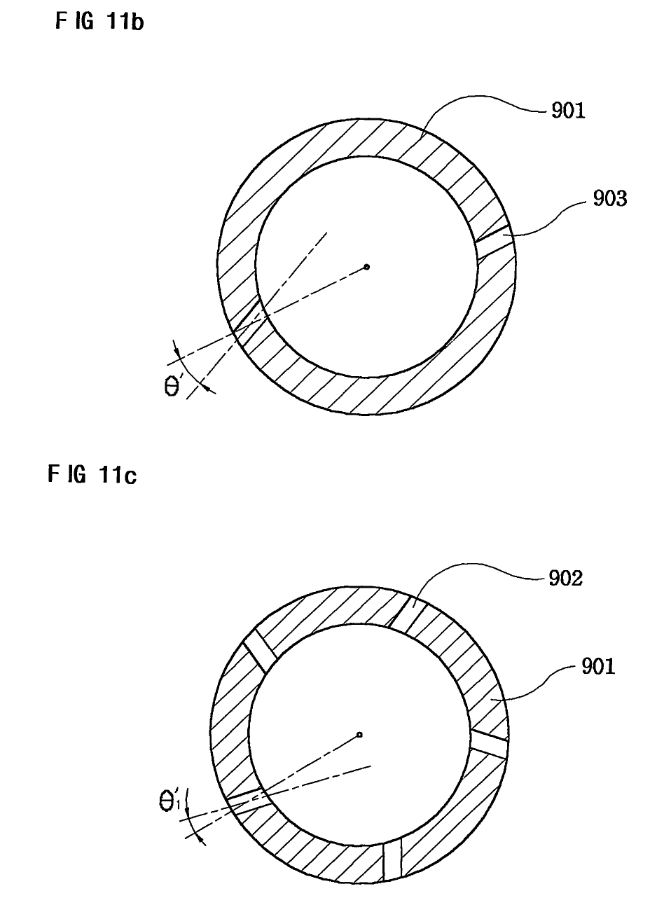

FIGS. 9 to 11 show another example of the garlic bulb splitting part or the garlic clove peeler. In this embodiment, one or two forced discharging nozzles 903 are provided on the upper portion of a group of nozzles 902 of a garlic bulb or clove putting tube 901, for forcibly discharging the garlic bulbs or garlic cloves in a downward direction, each of the one or two forced discharging nozzles having a larger downward inclination angle than the group of nozzles 902, slanted in a left or right direction. A discharging outlet 904 is provided with a sliding opening/closing door 905 for adjusting the time during which the garlic bulbs or garlic cloves stay in the garlic bulb or clove putting tube 901, with a guide 906 for guiding the sliding direction of the opening/closing door 905, and with a fixing stand 908 disposed at the outside of the opening/closing door 905, for fixing the opening/closing door 905 to the guide 906. The opening/closing door 906 is provided with a packing plate 909 that is disposed on the contact portion with the guide 906, for tightly contacting the guide 906, and a handle grip 910 that is disposed at the top end thereof.

The downward inclination angle of each of the forced discharging nozzles 903 is set larger than those of the group of nozzles 902 (i.e., θ>θ₁>θ₂>θ₃), and the left or right inclination angle thereof is set larger than those of the group of nozzles 902 (i.e., e, θ>θ₁≈θ₂), such that the forced discharging nozzles 903 are rotated at a relatively larger angle.

With the forced discharging nozzles 903 mounted in such the manner as mentioned above, a substantially strong stream of water is injected downwardly from the upper side of the garlic bulb or clove putting tube 901, breaking the force and balance supported by the lower nozzles 902 with a result of discharging the garlic cloves or the garlic meats to the outside.

By the way, if the garlic cloves or the garlic meats are discharged at a relatively fast speed, there occur some advantages that the garlic bulbs or garlic cloves are thrown at an appropriate speed and the garlic meats are less damaged. However, the peeling processing time is too short to obtain a high peeling result. In order to get a high degree of peeling, it should be therefore appreciated that the time during which the garlic bulbs or garlic cloves stay in the tube 901 is appropriately determined. To accomplish this, the discharging outlet 904 has the guide 906 and the opening/closing door 905 that is slidable along the guide 906 such that it can be adjusted in size. In more details, the guide 906 is formed around the discharging outlet 904 in such a manner as to become the discharging outlet 904 in the middle thereof. The discharging outlet 904 is closed when the opening/closing door 905 is completely down to the lower portion of the discharging outlet 904, and it becomes larger as the opening/closing door 905 is opened. Upon the processing of the garlic, therefore, the height of the opening/closing door 905 is appropriately adjusted, while checking that the discharging speed, the amount of putting to the tube, the pressure of water, the peeling degree, the degree of damage on the garlic, and so on. After the adjustment, it is tightly fixed to the guide 906 by means of the bolt 907 on the fixing stand 908. This causes the above-mentioned checking requirements for the garlic to be in best conditions.

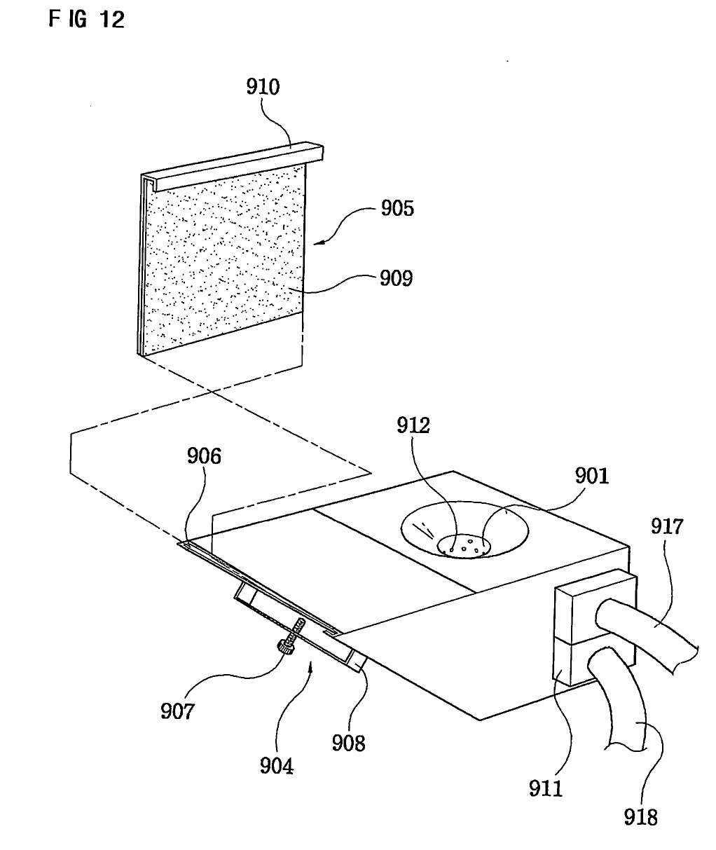

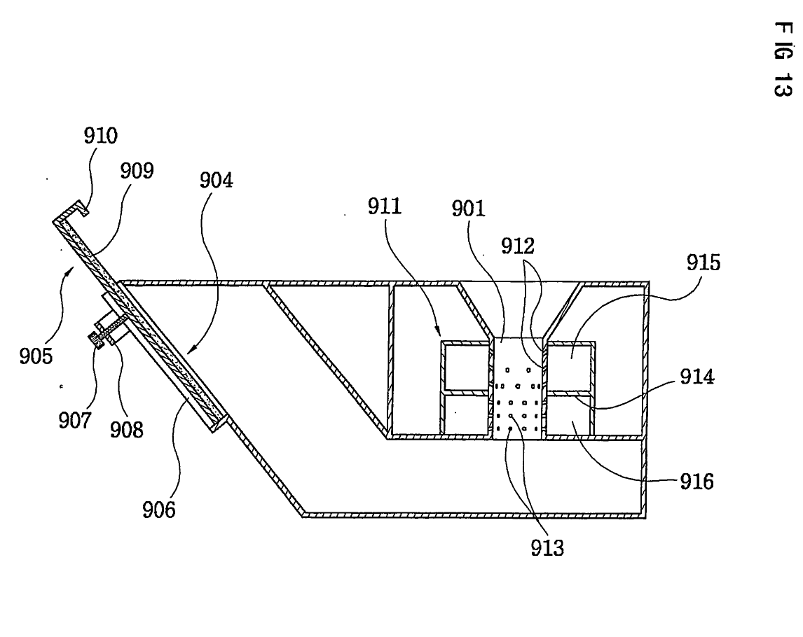

FIGS. 12 and 13 show yet another example of the garlic bulb splitting part or the garlic clove peeler. In this embodiment, a water storing tank 911 has at least one or more sets of processing nozzles 913 having downward, horizontal and upward injection directions in the interior thereof, pressurizing nozzles 912 having only a downward injection direction therein, and a compartment 914 laying between the sets of processing nozzles 913 and the pressurizing nozzles 912 such that the upper portion of the compartment 914 forms a pressurizing nozzle pressurizing chamber 915 and the lower portion thereof forms a processing nozzle pressurizing chamber 916. Each of the pressurizing chambers 915 and 915 is connected with water supply pipes 917 and 918 each connected to different pumps, for supplying water in different pressures to the pressurizing nozzles 912 and the processing nozzles 913.

In conventional practice, the garlic bulb splitting part or the garlic clove peeling part has the processing nozzles 913 that has the downward, horizontal, and the upward injection directions at the lower portion thereof, so that the garlic is not discharged at a fast speed, and the pressurizing nozzles 912 that has the same water pressures as one another, spaced equally in a circumferential direction at the upper portion thereof, so that the garlic is not discharged well, which causes some problems that the garlic is not easy to be thrown, the garlic overflows, the damages of garlic are serious, and especially the processing of garlic is continuously done so that the density of water is changed to generate a great number of waterdrops accompanying the increase of back pressure. In such the configuration as mentioned in the embodiment in FIGS. 12 and 13, however, when the garlic is not discharged well due to the raising of water temperature resulting from the maintenance of the processing of garlic, the pumping force of the pump connected to the pressurizing nozzle pressurizing chamber 915 is set larger than that of another pumps so that strong stream of water is injected through the pressurizing nozzles 912 at the upper portion. This enables the garlic bulbs or the garlic cloves to be forcibly discharged.

Also, the garlic has the outer skins different in thickness in accordance with the kinds, and if it has a relatively thin outer skin, the water pressure should be desirably weak. In this case, the water pressure of the pressurizing nozzles 912 is set lower than that of the processing nozzles 913, which enables the discharging speed of the garlic to be delayed.

In addition thereto, at this time, the opening/closing door 905 is desirably controlled in the size to be opened or closed. This also enables the garlic bulbs or the garlic cloves to be discharged at an appropriate speed.

### INDUSTRIAL APPLICABILITY

As set forth in the foregoing, the apparatus of this invention is provided with the garlic bulb splitting part and the garlic clove peeling part that have different structures from each other, to thereby improve the capabilities both in the separation of the garlic bulbs and the peeling of the outer skins of the garlic cloves and to thereby improve the separation of the garlic meats from the outer skins in the steps where the garlic cloves are thrown into each garlic clove peeler, and with a separate water discharging tank for purifying the water used for the peeling of the garlic before discharging to thereby prevent environmental contamination.

While the present invention has been described with reference to a few specific embodiments, the description is illustrative of the invention and is not to be construed as limiting the invention. Various modifications may occur to those skilled in the art without departing from the true spirit and scope of the invention as defined by the appended claims.

What is claimed is:

1. An apparatus for peeling the outer skins of garlic using a wet process, comprising:
a garlic bulb splitting part for injecting high-pressure water to garlic bulbs to split the garlic bulbs into individual garlic cloves;
a garlic clove peeling part having at least three garlic clove peelers arranged one after another and a conveyor provided between adjacent garlic clove peelers for separating and conveying the outer skins and the garlic meats containing water therein discharged from each garlic clove peeler, the garlic clove peeling part adapted to inject high-pressure water to the split garlic cloves when the split garlic cloves are provided from the garlic bulb splitting part to thereby peel the outer skins of the garlic cloves;
a dry part for blowing air to the garlic meats by means of an air blower such that the garlic meats are fully dried, while conveying the garlic meats from the garlic clove peeling part through a conveyor;
an outer skin separating part provided between the garlic bulb splitting part and a first garlic clove peeler and between a final garlic clove peeler and the dry part, respectively, for conveying the garlic cloves or the garlic meats from the garlic bulb splitting part or the garlic clove peeling part such that the garlic meats are dropped to first and second water paths by the control of an installation angle thereof and the outer skins are caught by first and second meshes conveyors;
an outer skin discharging part provided with a discharging chamber having a gutter communicating with the lower portions of the first and second meshes conveyors and with the lower portion of each conveyor of the garlic clove peeling part, a perforated plate communicating with the gutter, and a brush conveyor for sweeping and discharging the water and outer skins dropped through the gutter flowing into the discharging chamber;
a water circulating part having a first settling tank for pumping water to each garlic clove peeler, a second settling tank placed to gather water filtered through the perforated plate at the lower portion of the discharging chamber, pumping the water to the first water path of the first meshes conveyor and the first settling tank, and a third settling tank placed at the lower portion of the dry part, for supplying water to the second water path of the second meshes conveyor and for circulating the water gathering again through the dry part; and
a water discharging tank having a fourth settling tank and a filtering tank, the filtering tank having activated charcoal filled therein and filtering meshes provided at the upper portion thereof, for purifying the water flowing from the fourth settling tank by the use of the activated charcoal when the water is pumped from the first settling tank to discharge the purified water.

2. The apparatus according to claim 1, wherein the garlic bulb splitting part comprises: a garlic bulb putting hopper into which garlic bulbs are thrown; a cylindrical garlic bulb putting tube into which the garlic bulbs are put, extended downwardly from the garlic bulb putting hopper; a group of multistage nozzles spaced equally along a circumferential direction from the middle portion to the lower portion of the garlic bulb putting tube; a water storing tank placed near the garlic bulb putting tube for supplying water to the group of multistage nozzles; a conveying passage communicating in a horizontal direction with the lower end of the garlic bulb putting tube; and a discharging outlet communicating slantly in an upward direction with the conveying passage, wherein the group of multistage nozzles have reference nozzles that are positioned in a vertical direction to the garlic bulb putting tube at the lower portion of the garlic bulb putting tube, upper nozzles that are positioned at the upper portion with respect to the reference nozzles, spaced at intervals that become large by stages and slanted at angles that become large by stages toward the lower portion as they reach the upper portion, and lower nozzles that are positioned at the lower portion with respect to the reference nozzles, spaced at intervals that become large by stages and slanted at angles that become large by stages toward the upper portion as they reach the lower portion, the reference nozzles being formed in such a manner that the unit nozzles aligned along the circumferential direction are directed to the middle portion of the garlic bulb putting tube, the unit nozzles of the upper and lower nozzles being formed in turn in such a manner as to be directed to the left or right with respect to the middle portion of the garlic bulb putting tube.

3. The apparatus according to claim 1, wherein each of the garlic clove peelers in the garlic clove peeling part comprises: a garlic clove putting hopper into which garlic cloves are thrown; a cylindrical garlic clove putting tube into which the garlic cloves are put, extended downwardly from the garlic clove putting hopper; a group of multistage nozzles spaced equally along a circumferential direction from the middle portion to the lower portion of the garlic clove putting tube; a water storing tank placed near the garlic clove putting tube for supplying water to the group of multistage nozzles; a conveying passage communicating in a horizontal direction with the lower end of the garlic clove putting tube; and a discharging outlet communicating slantly in an upward direction with the conveying passage, wherein the group of multistage nozzles are provided with at least two sets of peeling nozzles each having the three-stage nozzles starting at the lower portion thereof, each set of peeling nozzles having intermediate nozzles positioned in a vertical direction to the garlic clove putting tube, upper nozzles positioned slantly in a downward direction, and lower nozzles positioned slantly in an upward direction in such a manner as to be symmetrical to the upper nozzles, the upper nozzles at the upper portion with respect to the sets of peeling nozzles being positioned slantly downwardly at a larger angle than the slanted angle of the upper or lower nozzles of the sets of peeling nozzles, the intermediate nozzles of each of the two sets of peeling nozzles being formed in such a manner that the unit nozzles aligned along the circumferential direction are directed to the middle portion of the garlic clove putting tube, the unit nozzles of the upper and lower nozzles being formed in turn in such a manner as to be directed to the left or right with respect to the middle portion of the garlic clove putting tube.

4. The apparatus according to claim 2 or 3, wherein the garlic bulb or garlic clove putting tube has one or two forced discharging nozzles on the upper portion thereof, for forcibly discharging the garlic bulbs or garlic cloves in a downward direction, each of the one or two forced discharging nozzles having a larger downward inclination angle than the group of nozzles, slanted in a left or right direction, and has a discharging outlet provided with a sliding opening/closing door for adjusting the time during which the garlic bulbs or garlic cloves stay in the garlic bulb or garlic clove putting tube.

5. The apparatus according to claim 4, wherein the discharging outlet has a guide for guiding the sliding direction of the opening/closing door and a fixing stand disposed at the outside of the opening/closing door, for fixing the opening/closing door to the guide, the opening/closing door having a packing plate disposed on the contact portion with the guide, for tightly contacting the guide and having a handle grip disposed at the top end thereof.

6. The apparatus according to claim 4, wherein a water storing tank has at least one or more sets of processing nozzles having downward, horizontal and upward injection directions in the interior thereof, pressurizing nozzles having only a downward injection direction therein, and a compartment laying between the sets of processing nozzles and the pressurizing nozzles such that the upper portion of the compartment forms a pressurizing nozzle pressurizing chamber and the lower portion thereof forms a processing nozzle pressurizing chamber, each of the pressurizing chambers being connected with first and second water supply pipes each connected to different pumps, for supplying water in different pressures to the pressurizing nozzles and the processing nozzles.

7. The apparatus according to claim 1, wherein the dry part comprises a garlic meat discharging part at the rear thereof, the garlic meat discharging part having a post-processing conveyor where the garlic cloves that have not been peeled off, the outer skins, and the garlic stalks are separated manually, a washing tank, a dewatering conveyor for removing the water remaining on the garlic meats by use of air blowers, and a size sorter on which the garlic meats are sorted by sizes as it is vibrated.

8. The apparatus according to claim 1, wherein the filtering meshes of the water discharging tank have a W-shaped section portion such that water flows to the central portion thereof.

9. The apparatus according to claim 1, wherein the dry part and the one side of the discharging chamber are connected via a predetermined pipe, such that the outer skins blowing while dried in the dry part are sent to the discharging chamber.
